(19) United States
(12) Patent Application Publication
(10) Pub. No.: US 2026/0176145 A1
(43) Pub. Date: Jun. 25, 2026

(54) LOW TEMPERATURE PURIFICATION OF METAL SULFIDES

(71) Applicant: Solid Power Operating, Inc., Louisville, CO (US)

(72) Inventors: Benjamin A. CARLSON, St. Paul, MN (US); Samuel M. OBERWETTER, Lafayette, CO (US); Clara MAUSER, Broomfield, CO (US); Brian E. FRANCISCO, Arvada, CO (US)

(21) Appl. No.: 19/425,597

(22) Filed: Dec. 18, 2025

Related U.S. Application Data
(60) Provisional application No. 63/736,329, filed on Dec. 19, 2024.

(51) Int. Cl. C01B 33/00; C01B 35/14; C01G 19/00; C01G 25/00

(52) U.S. Cl. CPC C01B 33/00; C01B 35/14; C01G 19/00; C01G 25/00; C01P 2006/40

(57) ABSTRACT

Methods for purifying metal sulfides include combining an alkali metal sulfide and composites that include a metal sulfide in an aprotic solvent, filtering undissolved solids from the mixture, and adding a secondary sulfide to the solution to precipitate the highly pure metal sulfide. The purified metal sulfides may be used in the production of solid-state electrochemical cells.

### CROSS-REFERENCE TO RELATED APPLICATION

This application is related to and claims priority under 35 U.S.C. § 119 from U.S. Provisional Application No. 63/736,329 filed Dec. 19, 2024, titled “Low Temperature Purification of Metal Sulfide,” the entire contents of which are fully incorporated by reference herein for all purposes.

### TECHNICAL FIELD

The present disclosure is related to processes for purifying metal sulfides for use in a solid-state electrochemical cell, such as a solid-state battery.

### BACKGROUND

The demand for advanced electronics, microchips, and processors is at an all-time high, and, as such, the demand for the materials to make them has never been higher. Of these materials, industries have been drawn to silicon sulfide. Methods of synthesizing silicon sulfide generally proceed by reacting a silicon-containing material with a sulfur-containing material at high temperatures. Some examples of these high temperature syntheses are reacting silicon metal with elemental sulfur (Si+S→SiS₂) or reacting silica with carbon disulfide (SiO₂+CS₂→SiS₂+CO₂). Unfortunately, forming pure silicon sulfide from these methods is challenging. When reacting silicon metal with elemental sulfur, the final composite may contain unreacted silicon metal. Similarly, when reacting silica with carbon disulfide, the final composite may contain unreacted silica. The standard way to produce a pure silicon sulfide material has been to heat the composite containing the silicon sulfide to the point where the silicon sulfide evaporates at around 1100° C. Once in the gas phase, the material can be recondensed in a separate location and, thus, a pure silicon sulfide material may be produced. This is a complex procedure because the gas phase silicon sulfide is highly reactive, and must be kept in a generally oxygen-free environment.

It is with these observations in mind, among others, that aspects of the present disclosure were conceived.

### SUMMARY

Provided herein are methods for purifying a metal sulfide. The methods generally include combining an alkali metal sulfide, a composite comprising the metal sulfide, and an aprotic solvent to produce a mixture of undissolved materials and a solution comprising the metal sulfide and the alkali metal sulfide, wherein the metal sulfide and the alkali metal sulfide are dissolved in the solution; removing the undissolved materials; adding a secondary sulfide to the solution comprising the metal sulfide and the alkali metal sulfide, thereby precipitating the metal sulfide; and collecting the metal sulfide. In some embodiments, the molar ratio of the metal sulfide to the alkali metal sulfide is from 1:10 to 1:1. In some embodiments, the alkali metal sulfide comprises Li₂S, LiNaS, or LiKS. In some embodiments, the metal sulfide comprises boron, silicon, germanium, antimony, or tellurium. In some embodiments, the metal sulfide comprises titanium, tungsten, silver, molybdenum, zirconium, hafnium, scandium, vanadium, chromium, manganese, iron, cobalt, nickel, copper, zinc, yttrium, niobium, technetium, ruthenium, rhodium, palladium, cadmium, tantalum, rhenium, osmium, iridium, platinum, gold, mercury, aluminum, gallium, indium, thallium, tin, lead, silicon, boron, germanium, or bismuth. In an exemplary embodiment, the metal sulfide comprises silicon, boron, zirconium, or tin. In some embodiments, the solvent comprises an ether, ester, nitrile, or imine. In some embodiments, the secondary sulfide comprises P₄S₃, P₄S₄, P₄S₅, P₄S₆, P₄S₇, P₄S₈, P₄S₉, P₄S₁₀ (P₂S₅), P₄Sₓ where 10<x<50, or any combination thereof. In some embodiments, the composite further comprises a metal oxide, metal carbide, or carbon.

Further provided herein are methods for purifying a metal sulfide. The methods generally include combining a first alkali metal sulfide, a first alkali metal salt, and a solvent forming a mixture of a second alkali metal salt and a second alkali metal sulfide; adding a composite comprising a metal sulfide to produce a mixture of undissolved materials and a solution comprising a metal sulfide and a second alkali metal sulfide; removing the undissolved materials; adding a secondary sulfide to the solution, thereby precipitating the metal sulfide; and collecting the metal sulfide. In some embodiments, the first alkali metal sulfide comprises Na₂S, LiNaS, LiKS, or K₂S. In some embodiments, the first alkali metal salt comprises LiF, LiCl, LiBr, LiI, lithium carbonate, lithium sulfate, lithium hydroxide, or lithium phosphate. In some embodiments, the combining step further comprises an alkali earth metal selected from the group consisting of magnesium or calcium. In some embodiments, the aprotic solvent comprises an ether, ester, nitrile, or imine. In some embodiments, the second alkali metal sulfide comprises Li₂S, LiNaS, or LiKS. In some embodiments, the first alkali metal salt comprises NaF, NaCl, NaBr, Nal, sodium carbonate, sodium sulfate, sodium hydroxide, sodium phosphate, KF, KCl KBr, Kl, potassium carbonate, potassium sulfate, potassium hydroxide, or potassium phosphate. In some embodiments, the metal sulfide comprises titanium, tungsten, silver, molybdenum, zirconium, hafnium, scandium, vanadium, chromium, manganese, iron, cobalt, nickel, copper, zinc, yttrium, niobium, technetium, ruthenium, rhodium, palladium, cadmium, tantalum, rhenium, osmium, iridium, platinum, gold, mercury, aluminum, gallium, indium, thallium, tin, lead, silicon, boron, germanium, or bismuth. In an exemplary embodiment, the metal sulfide comprises silicon, boron, zirconium, or tin.

Further provided herein are methods for purifying a metal sulfide. The methods generally comprise combining Na₂S, LiCl, and a nitrile solvent to form a mixture of NaCl and a second alkali metal sulfide; adding a composite comprising a metal sulfide to produce a mixture of undissolved materials and a solution comprising the metal sulfide and the second alkali metal sulfide; removing the undissolved materials; adding P₂S₅ to the solution, thereby precipitating the metal sulfide; and collecting the metal sulfide. In some embodiments, the second alkali metal sulfide comprises Li₂S or LiNaS. In some embodiments, the nitrile solvent comprises acetonitrile, propionitrile, butyronitrile, isobutyronitrile, benzonitrile, decanonitrile, pivalonitrile, or valeronitrile. In some embodiments, the metal sulfide comprises titanium, tungsten, silver, molybdenum, zirconium, hafnium, scandium, vanadium, chromium, manganese, iron, cobalt, nickel, copper, zinc, yttrium, niobium, technetium, ruthenium, rhodium, palladium, cadmium, tantalum, rhenium, osmium, iridium, platinum, gold, mercury, aluminum, gallium, indium, thallium, tin, lead, silicon, boron, germanium, or bismuth. In an exemplary embodiment, the metal sulfide comprises silicon, boron, zirconium, or tin.

### BRIEF DESCRIPTION OF DRAWINGS

The present disclosure may be understood by reference to the following detailed description taken in conjunction with the drawings briefly described below. It is noted that, for purposes of illustrative clarity, certain elements in the drawings may not be drawn to scale.

FIG. 1 is a schematic illustration of a process according to an embodiment of the present disclosure.

FIGS. 2A and 2B are schematic illustrations of processes according to certain embodiments of the present disclosure.

FIG. 3 shows X-ray diffraction (XRD) patterns of the first purified metal sulfide resulting from Example 1 of the present disclosure.

### DETAILED DESCRIPTION OF ILLUSTRATED EMBODIMENTS

Various aspects of the present invention are disclosed and described, it is to be understood that this invention is not limited to the particular methods, compositions, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range or the characteristics being described.

As used herein, the term “about” is used to provide flexibility to a numerical range endpoint by providing that a given value may be “a little above” or “a little below” the endpoint. For example, the endpoint may be within 10%, 8%, 5%, 3%, 2%, or 1% of the listed value. Further, for the sake of convenience and brevity and in another example, a numerical range of “about 50 mg/mL to about 80 mg/mL” should also be understood to provide support for the range of “50 mg/mL to 80 mg/mL.”

In this disclosure, the terms “including,” “containing,” and/or “having” are understood to mean comprising, and are open ended terms.

In this disclosure, unless otherwise specified, the term “metal” refers to metalloids, transition metals, or post-transition metals, and alloys or mixtures thereof. The term “metal” does not refer to alkali metals.

The current disclosure provides a method for purifying a metal sulfide by combining an alkali metal sulfide and a composite containing a metal sulfide with a solvent. The metal sulfide may be included in a composite that includes other materials. This combination produces a surprising synergistic solubilization effect where the metal sulfide and the alkali metal sulfide dissolve into the solvent, while leaving the other components of the composite containing the metal sulfide in solid form. The solubilized metal sulfide and alkali metal sulfide may be separated from any solids by filtering, decanting, or centrifuging. In another surprising effect, the solubilized metal sulfide may be forced out of solution to form a precipitate by the addition of a secondary sulfide. The now-solid metal sulfide may be separated from the solution by filtering, decanting, or centrifuging. Once collected, the purified metal sulfide may be dried and heated to an elevated temperature to grow particle size or to crystalize the material.

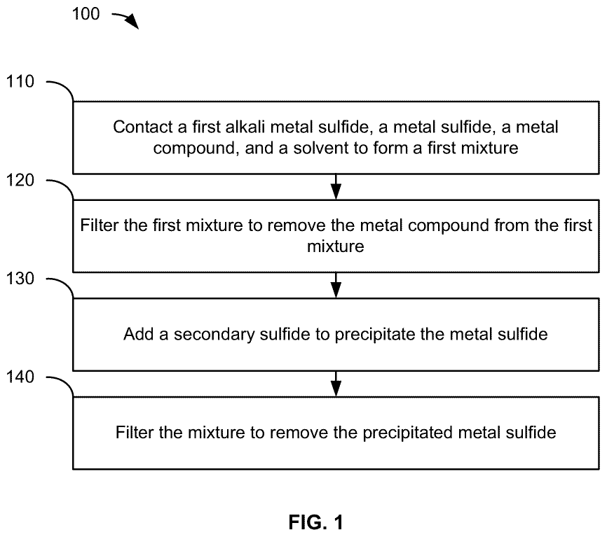

A graphical representation of an embodiment of the methods of the present disclosure is provided in FIG. 1. The method 100 begins at step 110 by combining a first alkali metal sulfide, a metal sulfide, a metal compound, and a solvent to form a first mixture. At this stage, the metal sulfide and the alkali metal sulfide dissolve into the solvent, while leaving the other components of the composite containing the metal sulfide in solid form. Next, at step 120, the mixture is filtered to remove the metal compound from the first mixture. Next, at step 130, a secondary sulfide is added to the mixture to precipitate the metal sulfide. Next, at step 140, the mixture is filtered to remove the precipitated metal sulfide. The general reaction is also provided below:
1. Combine metal sulfide, alkali metal sulfide, metal compound, and solvent

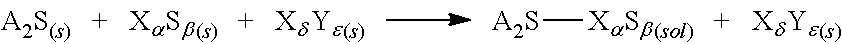

2. Filter to remove undissolved materials

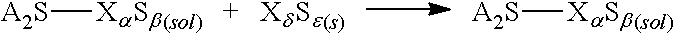

3. Add secondary sulfide material to precipitate metal sulfide

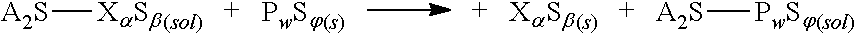

4. Filter to recover metal sulfide

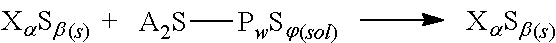

5. (Optionally) drying and heating

In the reactions above, A₂S is an alkali metal sulfide; X_{α}S_{β} is a metal sulfide; and X_{δ}Y_{ε} is a metal compound that may include a metal oxide, a metal carbide, or an elemental metal. It is further noted that the species X in the metal sulfide and the metal compound are the same element. Generally, the metal compound and the metal sulfide may be provided in the form of a composite material comprising both the metal sulfide and the metal compound. In some embodiments, the alkali metal sulfide, the metal compound, and the metal sulfide may be provided in the form of a composite material comprising all three of the alkali metal sulfide, the metal sulfide, and the metal compound.

In the reactions above, A is an alkali metal. Non-limiting examples of alkali metals include lithium, sodium, potassium, rubidium, cesium, or a combination thereof. In a preferred embodiment, the alkali metal includes lithium.

In the reactions above, X may include a metalloid, transition metal, or post-transition metal. Non-limiting examples of metalloids include boron, silicon, germanium, or antimony. Non-limiting examples of transition metals include titanium, tungsten, silver, molybdenum, zirconium, hafnium, scandium, vanadium, chromium, manganese, iron, cobalt, nickel, copper, zinc, yttrium, niobium, technetium, ruthenium, rhodium, palladium, cadmium, tantalum, rhenium, osmium, iridium, platinum, gold, mercury, and any combination thereof. Non-limiting examples of post-transition metals include aluminum, gallium, indium, thallium, tin, lead, bismuth, and any combination thereof. In a preferred embodiment, X includes silicon. In another embodiment, X includes tin. In yet another embodiment, X includes zirconium. In yet another embodiment, X includes boron.

In the reactions above, Y may include oxygen or carbon.

In the reactions above, α is a number from about 1 to about 5. In some embodiments, a may be about 1.0, about 1.1, about 1.2, about 1.3, about 1.4, about 1.5, about 1.6, about 1.7, about 1.8, about 1.9, about 2.0, about 2.1, about 2.2, about 2.3, about 2.4, about 2.5, about 2.6, about 2.7, about 2.8, about 2.9, about 3.0, about 3.1, about 3.2, about 3.3, about 3.4, about 3.5, about 3.6, about 3.7, about 3.8, about 3.9, about 4.0, about 4.1, about 4.2, about 4.3, about 4.4, about 4.5, about 4.6, about 4.7, about 4.8, about 4.9, or about 5.0.

In the reactions above, β is a number from about 1 to about 10. In some embodiments, p may be about 1, about 2, about 3, about 4, about 5, about 6, about 7, about 8, about 9, or about 10.

In the reactions above, δ is a number from 1 to about 5. In some embodiments, b may be about 1.0, about 1.1, about 1.2, about 1.3, about 1.4, about 1.5, about 1.6, about 1.7, about 1.8, about 1.9, about 2.0, about 2.1, about 2.2, about 2.3, about 2.4, about 2.5, about 2.6, about 2.7, about 2.8, about 2.9, about 3.0, about 3.1, about 3.2, about 3.3, about 3.4, about 3.5, about 3.6, about 3.7, about 3.8, about 3.9, about 4.0, about 4.1, about 4.2, about 4.3, about 4.4, about 4.5, about 4.6, about 4.7, about 4.8, about 4.9, or about 5.0.

In the reactions above, ε is a number from about 0 to about 10. In some embodiments, ε may be about 0, about 1, about 2, about 3, about 4, about 5, about 6, about 7, about 8, about 9, or about 10.

In the reactions above, φ is a number from about 3 to about 40, such as from about 3 to about 10, about 3 to about 20, about 3 to about 30, or about 3 to about 40. In some embodiments, φ may be about 3, about 4, about 5, about 6, about 7, about 8, about 9, about 10, about 15, about 20, about 25, about 30, about 35, or about 40.

In the reactions above, W is a number from about 1 to about 4. In some embodiments, W may be about 1, about 2, about 3, or about 4.

The above reactions may be carried out in a solvent. The solvent may be an aprotic solvent include but are not limited to esters, ethers, nitriles, or hydrocarbons. Esters may include but are not limited to ethyl acetate, ethyl butyrate, isobutyl acetate, butyl acetate, butyl butyrate and butyl propanoate. Ethers may include but are not limited to diethyl ether, diglyme, tetrahydrofuran (THF), dibutyl ether, dipentyl ether, dimethoxyethane (DME), dioxane, or anisole. Nitriles may include but are not limited to acetonitrile, propionitrile, butyronitrile, isobutyronitrile, benzonitrile, decanonitrile, pivalonitrile, valeronitrile. The solvent may further include a hydrocarbon solvent which may include an alkane, a blend of alkanes, xylene (including para-, meta-, and ortho-xylene), toluene, benzene, heptane, octane, decalin, 1,2,3,4-tetrahydronaphthalene, or combinations thereof. The blend of alkanes may include alkane solvents including from 4 to 20 carbon atoms. Other useful solvents may include DMSO, acetone, DMA, chloroform, methyl dichloride, pyridine, or alkanes, alkenes, alkynes, and combinations thereof, including but not limited to those with linear, branched, or ring structures and boiling points between 30° C. and 250° C.

The secondary sulfide may include P₄S₃, P₄S₄, P₄S₅, P₄S₆, P₄S₇, P₄S₈, P₄S₉, P₄S₁₀ (P₂S₅), or any combination thereof. The secondary sulfide may additionally or alternatively include P₄Sₓ, where 10<x<50, such as P₄S₁₁, P₄S₁₂, P₄S₁₃, P₄S₁₄, P₄S₂₀, P₄S₅₀, or any combination thereof.

The molar ratio of the metal sulfide to the alkali metal sulfide may be from 1:10 to 1:1, such as from 1:10 to 1:1, 1:9 to 1:1, 1:8 to 1:1, 1:7 to 1:1, 1:6 to 1:1, 1:5 to 1:1, 1:4 to 1:1, 1:3 to 1:1, or 1:2 to 1:1. As another example, the molar ratio of the metal sulfide to the alkali metal sulfide may be 1:10, 1:9, 1:8, 1:7, 1:6, 1:5, 1:4, 1:3, 1:2, or 1:1.

In some examples, the alkali metal sulfide may include Li₂S, LiNaS, K₂S, Na₂S, or LiKS.

When combining the alkali metal sulfide, the metal sulfide, the metal compound, and the solvent, the combination may be mixed for about 1 minute, about 5 minutes, about 10 minutes, about 20 minutes, about 30 minutes, about 1 hour, about 2 hours, about 5 hours, about 10 hours, about 15 hours, about 24 hours, or about 48 hours. In one embodiment, the temperature may be room temperature, or within a temperature range of −10° C. to 100° C.

Mixing at any of the subsequent steps may be performed for about 1 minute, about 5 minutes, about 10 minutes, about 20 minutes, about 30 minutes, about 1 hour, about 2 hours, about 5 hours, about 10 hours, about 15 hours, about 24 hours, or about 48 hours. The temperature of this mixing may be room temperature, or within a temperature range of −10° C. to 100° C. The mixing may include shaking, grinding, pulverizing, tumbling, or a combination thereof.

Once collected, the metal sulfide may be washed, dried, heated, crystalized, or a combination thereof.

In some embodiments, the purified metal sulfide may be dried. Drying may be performed by spray drying, rotary drying, tray drying, fluidized bed drying, vacuum drying, or a combination thereof. The drying may take place for 1 minute to about 24 hours at a temperature ranging from about 60° C. to about 160° C. For example, the drying may take place at a temperature from about 60° C. to about 80° C., about 60° C. to about 100° C., about 60° C. to about 120° C., about 60° C. to about 140° C., about 60° C. to about 160° C., about 80° C. to about 160° C., about 100° C. to about 160° C., about 120° C. to about 160° C., about 140° C. to about 160° C., about 80° C. to about 140° C., or about 100° C. to about 120° C. The temperature may be about 60° C., about 61° C., about 62° C., about 63° C., about 64° C., about 65° C., about 66° C., about 67° C., about 68° C., about 69° C., about 70° C., about 71° C., about 72° C., about 73° C., about 74° C., about 75° C., about 76° C., about 77° C., about 78° C., about 79° C., about 80° C., about 81° C., about 82° C., about 83° C., about 84° C., about 85° C., about 86° C., about 87° C., about 88° C., about 89° C., about 90° C., about 91° C., about 92° C., about 93° C., about 94° C., about 95° C., about 96° C., about 97° C., about 98° C., about 99° C., about 100° C., about 101° C., about 102° C., about 103° C., about 104° C., about 105° C., about 106° C., about 107° C., about 108° C., about 109° C., about 110° C., about 110° C., about 111° C., about 112° C., about 113° C., about 114° C., about 115° C., about 116° C., about 117° C., about 118° C., about 119° C., about 120° C., about 121° C., about 122° C., about 123° C., about 124° C., about 125° C., about 126° C., about 127° C., about 128° C., about 129° C., about 130° C., about 131° C., about 132° C., about 133° C., about 134° C., about 135° C., about 136° C., about 137° C., about 138° C., about 139° C., or about 140° C.

Filtering the mixture at steps 120 or 140 may be accomplished using any filtration apparatus known in the art. Alternatively, the filtration step may be accomplished via decanting, centrifugation, gravity settling, or other methods known in the art or any combination thereof.

Further processing such as crystallization may be performed. To accomplish the crystallization, the material may be heated to a temperature from about 300° C. to about 700° C., such as from about 300° C. to about 400° C., about 300° C. to about 500° C., about 300° C. to about 600° C., about 300° C. to about 700° C., about 400° C. to about 700° C., about 500° C. to about 700° C., or about 600° C. to about 700° C. As another example, the material may be heated to a temperature of about 300° C., about 400° C., about 500° C., about 600° C., or about 700° C. The crystallization may be performed with a crystallizer, a kiln, an oven, or another apparatus known in the art.

In one embodiment, the first step of the purification method may start by combining lithium sulfide, a composite containing silicon sulfide and silicon metal and a solvent. This combination solubilizes the lithium sulfide and the silicon sulfide but not the silicon metal. The solubilized lithium sulfide and silicon sulfide may be separated from silicon metal by filtering, decanting, or centrifuging. Once the silicon metal has been removed, a secondary sulfide material such as P₂S₅ may be added to the solution containing the silicon sulfide and the lithium sulfide. Once added, the P₂S₅ may force the silicon sulfide out of solution and cause it to precipitate. The now-solid precipitated silicon sulfide may be separated from the solution by filtering, decanting, or centrifuging. Once collected, the purified silicon sulfide may be dried and heated to an elevated temperature to grow particle size or to crystalize the material. The general reaction is:
1. Combine composite containing silicon sulfide, silicon metal, lithium sulfide, and solvent

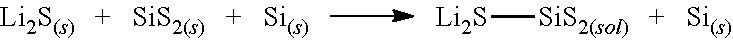

2. Filter to remove undissolved materials

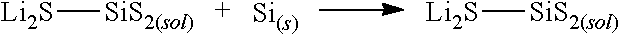

3. Add P₂S₅ to precipitate silicon sulfide

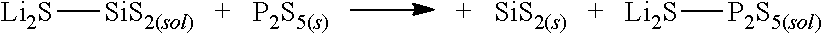

4. Filter to recover silicon sulfide

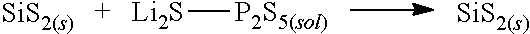

5. (Optionally) drying and heating

Another embodiment of the present disclosure is shown in the following general reaction:
1. Combine composite containing tin sulfide, tin metal, lithium sulfide, and solvent

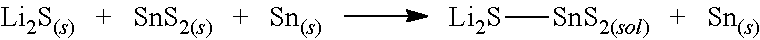

2. Filter to remove undissolved materials

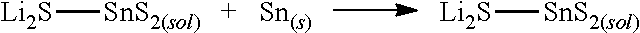

3. Add P₂S₅ to precipitate silicon sulfide

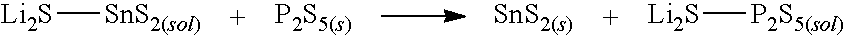

4. Filter to recover silicon sulfide

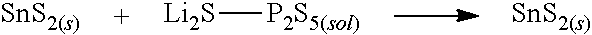

5. (Optionally) drying and heating

Another embodiment of the present disclosure is shown in the following general reaction:
1. Combine composite containing zirconium sulfide, zirconium metal, lithium sulfide, and solvent

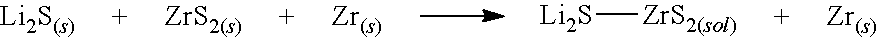

2. Filter to remove undissolved materials

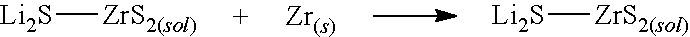

3. Add P₂S₅ to precipitate silicon sulfide

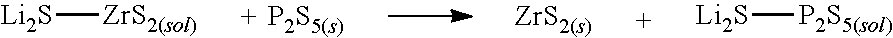

4. Filter to recover silicon sulfide

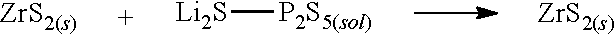

5. (Optionally) drying and heating

Another embodiment of the present disclosure is shown in the following general reaction:
1. Combine composite containing boron sulfide, boron, lithium sulfide, and solvent

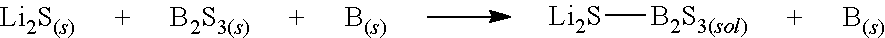

2. Filter to remove undissolved materials

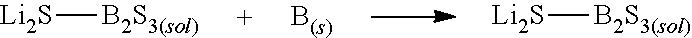

3. Add P₂S₅ to precipitate silicon sulfide

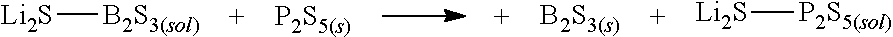

4. Filter to recover silicon sulfide

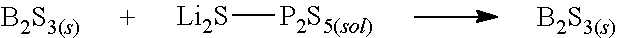

5. (Optionally) drying and heating

The current disclosure further provides a method of purifying a composite containing a metal sulfide. By combining a first alkali metal sulfide, a lithium salt, and an aprotic solvent a first mixture can be formed. This first mixture may be agitated to encourage a reaction between the first alkali metal sulfide and the lithium salt to form a second mixture containing a second alkali metal sulfide and an alkali metal salt. Once this second mixture is formed, a composite containing the metal sulfide is then combined with the second mixture containing the second alkali metal sulfide and the alkali metal salt. This combination promotes a solubilization effect between the metal sulfide and the second alkali metal sulfide, while keeping the other material in solid form, generating a third mixture. The solids in the third mixture can be removed by filtering them from the mixture. This filtering leaves a solution containing the metal sulfide and the second alkali metal sulfide. To this solution, a secondary sulfide is added. The secondary sulfide reacts with the solubilized second alkali metal sulfide, allowing for the solubilization of the secondary sulfide. This solubilization causes the metal sulfide to precipitate. Once precipitated, the metal sulfide may be collected from the solution by filtration. Once collected, the metal sulfide may be washed, dried, heated, crystalized, or a combination thereof.

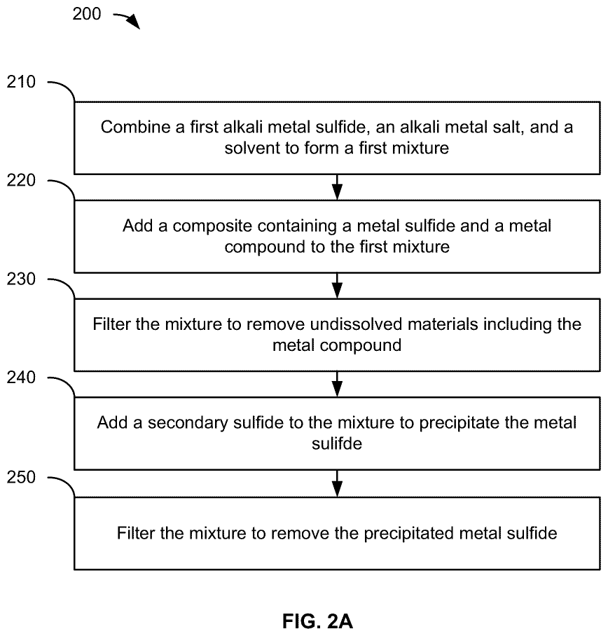

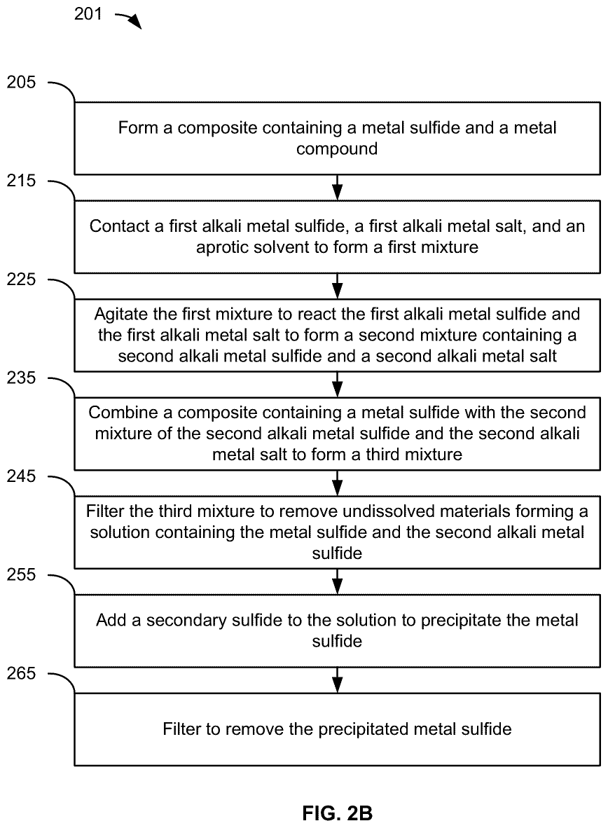

A graphical representation of an embodiment of the methods of the present disclosure is provided in FIG. 2A. The method 200 begins at step 210 by combining a first alkali metal sulfide, an alkali metal salt, and a solvent to form a first mixture. Next, at step 220, a composite containing a metal sulfide and a metal compound are added to the first mixture. At step 230, the mixture is filtered to remove the metal compound from the first mixture. Next, at step 240, a secondary sulfide is added to the mixture to precipitate the metal sulfide. Next, at step 250, the mixture is filtered to remove the precipitated metal sulfide. The general reaction is:
1. React a first alkali metal sulfide and an alkali metal salt in a solvent to form a first mixture

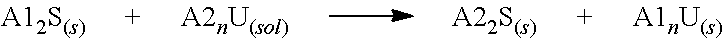

2. Combine a composite containing a metal sulfide and a metal compound with the first mixture

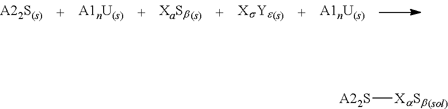

3. Filter to remove undissolved materials

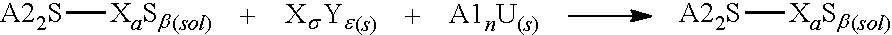

4. Add secondary sulfide to precipitate metal sulfide

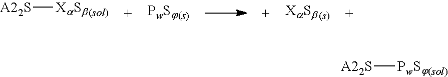

5. Filter to recover metal sulfide

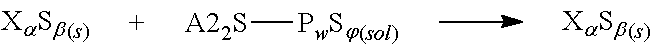

6. (Optionally) drying and heating

Another embodiment is shown in FIG. 2B. As shown in FIG. 2B, the method 201 may start at step 205 by first forming the composite containing a metal sulfide. contacting a first alkali metal sulfide, a first alkali metal salt, and an aprotic solvent to form a first mixture in step 215. In step 225, the first mixture is agitated to encourage a reaction between the first alkali metal sulfide and the first alkali metal salt to form a second mixture containing a second alkali metal sulfide and a second alkali metal salt. In step 235, the composite containing the metal sulfide is combined with the second mixture of the second alkali metal sulfide and the second alkali metal salt to form a third mixture. This combination promotes a solubilization effect between the metal sulfide and the second alkali metal sulfide, while keeping the other materials in solid form. In step 245, the solids in the third mixture are filtered to remove them from the mixture. The filtering leaves a solution containing the metal sulfide and the second alkali metal sulfide. In step 255, a secondary sulfide is added to the solution containing the metal sulfide and the second alkali metal sulfide. With the addition of the secondary sulfide, the second alkali metal sulfide solubilizes the secondary sulfide causing the metal sulfide to precipitate. Once precipitated, the metal sulfide is filtered away 265. Further washing, drying, heating, or crystalizing of the metal sulfide may be performed.

In the above reactions, A1₂S is the first alkali metal sulfide, A2ₙU is the first alkali metal salt, A2₂S is the second alkali metal sulfide, A1ₙU is the second alkali metal salt, X_{α}S_{β} is a metal sulfide, X_{δ}Y_{ε} is a metal compound metal compound that may include a metal oxide, a metal carbide, or an elemental metal. It is further noted that the species X in the metal sulfide and the metal compound are the same element. The metal sulfide and the metal compound may be provided in the form of a composite material comprising both the metal sulfide and the metal compound.

In the above reactions, A1 is an alkali metal. Non-limiting examples of alkali metals include Li, Na, K, Rb, Cs, or a combination thereof.

In the above reactions, A2 is an alkali metal. Non-limiting examples of alkali metals include Li, Na, K, Rb, Cs, or a combination thereof.

In the above reactions, U may include a halogen such as F, Cl, B, or I. U may alternatively include a carbonate (CO₃⁻), sulfate (SO₄²⁻), hydroxide (OH⁻), phosphate (PO₄³⁻), or nitrate (NO₃⁻).

In the above reactions, n is an integer 1, 2, or 3.

In the above reactions, X may include a metalloid, transition metal, or post-transition metal. Non-limiting examples of metalloids include boron, silicon, germanium, and antimony. Non-limiting examples of transition metals include titanium, tungsten, silver, molybdenum, zirconium, hafnium, scandium, vanadium, chromium, manganese, iron, cobalt, nickel, copper, zinc, yttrium, niobium, technetium, ruthenium, rhodium, palladium, cadmium, tantalum, rhenium, osmium, iridium, platinum, gold, mercury, and any combination thereof. Non-limiting examples of post-transition metals include aluminum, gallium, indium, thallium, tin, lead, bismuth, and any combination thereof. In a preferred embodiment, X includes silicon. In another embodiment, X includes tin. In yet another embodiment, X includes zirconium. In yet another embodiment, X includes boron.

In the above reactions, Y may include oxygen or carbon.

In the reactions above, α is a number from about 1 to about 5. In some embodiments, a may be about 1.0, about 1.1, about 1.2, about 1.3, about 1.4, about 1.5, about 1.6, about 1.7, about 1.8, about 1.9, about 2.0, about 2.1, about 2.2, about 2.3, about 2.4, about 2.5, about 2.6, about 2.7, about 2.8, about 2.9, about 3.0, about 3.1, about 3.2, about 3.3, about 3.4, about 3.5, about 3.6, about 3.7, about 3.8, about 3.9, about 4.0, about 4.1, about 4.2, about 4.3, about 4.4, about 4.5, about 4.6, about 4.7, about 4.8, about 4.9, or about 5.0.

In the reactions above, β is a number from about 1 to about 10. In some embodiments, p may be about 1, about 2, about 3, about 4, about 5, about 6, about 7, about 8, about 9, or about 10.

In the reactions above, δ is a number from 1 to about 5. In some embodiments, b may be about 1.0, about 1.1, about 1.2, about 1.3, about 1.4, about 1.5, about 1.6, about 1.7, about 1.8, about 1.9, about 2.0, about 2.1, about 2.2, about 2.3, about 2.4, about 2.5, about 2.6, about 2.7, about 2.8, about 2.9, about 3.0, about 3.1, about 3.2, about 3.3, about 3.4, about 3.5, about 3.6, about 3.7, about 3.8, about 3.9, about 4.0, about 4.1, about 4.2, about 4.3, about 4.4, about 4.5, about 4.6, about 4.7, about 4.8, about 4.9, or about 5.0.

In the reactions above, ε is a number from about 0 to about 10. In some embodiments, ε may be about 0, about 1, about 2, about 3, about 4, about 5, about 6, about 7, about 8, about 9, or about 10.

In the reactions above, φ is a number from about 3 to about 40, such as from about 3 to about 10, about 3 to about 20, about 3 to about 30, or about 3 to about 40. In some embodiments, φ may be about 3, about 4, about 5, about 6, about 7, about 8, about 9, about 10, about 15, about 20, about 25, about 30, about 35, or about 40.

In the reactions above, W is a number from about 1 to about 4. In some embodiments, W may be about 1, about 2, about 3, or about 4.

The above reactions may be carried out in a solvent. The solvent may be an aprotic solvent including but are not limited to esters, ethers, nitriles, or hydrocarbons. Esters may include but are not limited to ethyl acetate, ethyl butyrate, isobutyl acetate, butyl acetate, butyl butyrate and butyl propanoate. Ethers may include but are not limited to diethyl ether, diglyme, tetrahydrofuran (THF), dibutyl ether, dipentyl ether, dimethoxyethane (DME), dioxane, or anisole. Nitriles may include but are not limited to acetonitrile, propionitrile, butyronitrile, isobutyronitrile, benzonitrile, decanonitrile, pivalonitrile, valeronitrile. The solvent may further comprise a hydrocarbon solvent which may include an alkane, a blend of alkanes, xylene (including para-, meta-, and ortho-xylene), toluene, benzene, heptane, octane, decalin, 1,2,3,4-tetrahydronaphthalene, or combinations thereof. The blend of alkanes may include alkane solvents including from 4 to 20 carbon atoms. Other useful solvents may include DMSO, acetone, DMA, chloroform, methyl dichloride, pyridine, or alkanes, alkenes, alkynes, and combinations thereof, including but not limited to those with linear, branched, or ring structures and boiling points between 30° C. and 250° C.

The secondary sulfide may include P₄S₃, P₄S₄, P₄S₅, P₄S₆, P₄S₇, P₄S₈, P₄S₉, P₄S₁₀ (P₂S₅), or any combination thereof. The secondary sulfide may comprise P₄Sₓ, where 10<X<50, such as P₄S₁₁, P₄S₁₂, P₄S₁₃, P₄S₁₄, P₄S₂₀, P₄S₅₀, or any combination thereof.

The molar ratio of the metal sulfide to the first alkali metal sulfide may be from 1:10 to 1:1, such as from 1:10 to 1:1, 1:9 to 1:1, 1:8 to 1:1, 1:7 to 1:1, 1:6 to 1:1, 1:5 to 1:1, 1:4 to 1:1, 1:3 to 1:1, or 1:2 to 1:1. As another example, the molar ratio of the metal sulfide to the alkali metal sulfide may be 1:10, 1:9, 1:8, 1:7, 1:6, 1:5, 1:4, 1:3, 1:2, or 1:1.

In the above reactions, the formation of the composite containing the metal sulfide may be achieved by reacting a material containing the desired metal with a sulfur-containing material. Non-limiting examples of this may be reacting silicon metal with elemental sulfur at elevated temperature to generate a composite containing silicon metal, silicon sulfide, and elemental sulfur. (Si+S→Si+SiS₂+S). Another non-limiting example is to react silica with carbon disulfide at elevated temperatures to form a composite containing unreacted silica and silicon sulfide (SiO₂+CS₂→SiO₂+SiS₂+CO₂).

When combining the first alkali metal sulfide, the alkali metal salt, and the aprotic solvent, the combination may be mixed for about 1 minute, about 5 minutes, about 10 minutes, about 20 minutes, about 30 minutes, about 1 hour, about 2 hours, about 5 hours, about 10 hours, about 15 hours, about 24 hours, or about 48 hours.

In one embodiment, the temperature may be room temperature, or the temperature may be from about −10° C. to 100° C. For example, the temperature may be from about −10° C. to about 0° C., about −10° C. to about 25° C., about −10° C. to about 50° C., about −10° C. to about 75° C., about −10° C. to about 100° C., about 0° C. to about 100° C., about 25° C. to about 100° C., about 50° C. to about 100° C., or about 75° C. to about 100° C. As another example, the temperature may be about −10° C., 0° C., 10° C., 20° C., 30° C., 40° C., 50° C., 60° C., 70° C., 80° C., 90° C., or about 100° C.

In some embodiments, the first alkali metal sulfide may include one or more of Li₂S, LiNaS, Na₂S, LiKS, K₂S, or Cs₂S.

In some embodiments, the second alkali metal sulfide may include Li₂S, LiNaS, or LiKS, or any combination thereof.

In some embodiments, the first alkali metal salt may include LiCl, LiBr, LiI, Li₂CO₃, Li₂SO₄, LiOH, Li₃PO₄, or any combination thereof.

An alkali earth salt (A3) may be added to the solution alongside the first alkali metal salt, such as when using technical grade alkali salts that may include small amounts of alkali earth metal salts. The methods described herein may be suitable to further remove these alkali earth metals from the reactants, thereby improving the purity of the final product. The alkali earth metal salt may include MgCl₂, MgBr₂, Mgl₂, MgS, CaCl₂, CaBr₂, Cal₂, or any combination thereof. The alkali earth salt may precipitate in solution as it may not be soluble in the solvent. If the alkali earth salt is soluble in the solvent, then it may react with the alkali metal sulfide (e.g., Na₂S) to make an alkali earth metal sulfide, which may then precipitate.

The general reaction is:
1. Combine a first alkali metal sulfide, an alkali metal salt, and an alkali earth salt in a solvent to form a first mixture

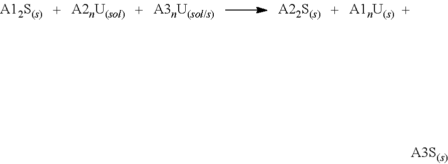

2. Combine a composite containing a metal sulfide and a metal compound with the first mixture

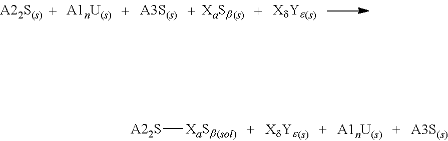

3. Filter to remove undissolved materials

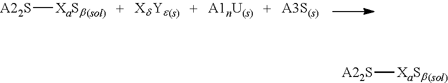

4. Add secondary sulfide to precipitate metal sulfide

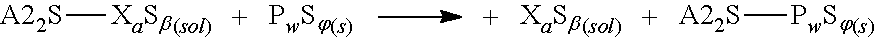

5. Filter to recover metal sulfide

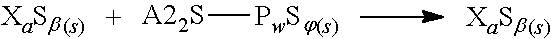

6. (Optionally) drying and heating

An exemplary embodiment using magnesium chloride as an alkali earth metal salt is shown below:
1. Combine sodium sulfide, lithium chloride, and magnesium chloride in a solvent to form a first mixture

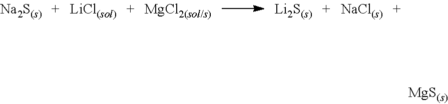

2. Add a composite containing silicon sulfide and silicon oxide to the first mixture

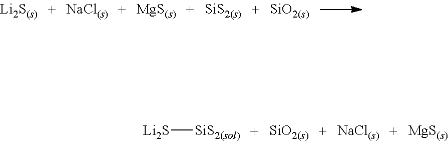

3. Filter to remove undissolved materials

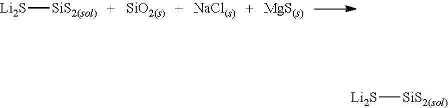

4. Add P₂S₅ to precipitate silicon sulfide

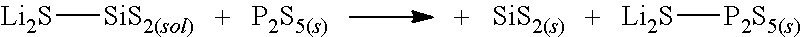

5. Filter to recover silicon sulfide

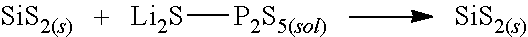

6. (Optionally) drying and heating

Mixing at any of the subsequent steps may be performed for about 1 minute, about 5 minutes, about 10 minutes, about 20 minutes, about 30 minutes, about 1 hour, about 2 hours, about 5 hours, about 10 hours, about 15 hours, about 24 hours, or about 48 hours. The temperature of this mixing may be room temperature, or within a temperature range of −10° C. to 100° C.

Agitation may be in the form of mixing, shaking, grinding, pulverizing, tumbling, or a combination thereof.

The first mixture may be agitated to encourage a reaction between the first alkali metal sulfide and the first alkali metal salt to form a second mixture containing a second alkali metal sulfide and a second alkali metal salt. Once this second mixture is formed, a composite containing the metal sulfide is then combined with the second mixture containing the second alkali metal sulfide and the second alkali metal salt. This combination promotes a solubilization effect between the metal sulfide and the second alkali metal sulfide, while keeping the other materials in solid form, generating a third mixture. The solids in the third mixture can be removed by filtering them from the mixture. The filtering leaves a solution containing the metal sulfide and the second alkali metal sulfide. To this solution, a secondary sulfide is added where the secondary sulfide reacts with the solubilized second alkali metal sulfide, allowing for the solubilization of the secondary sulfide. This solubilization causes the metal sulfide to precipitate. Once precipitated, the metal sulfide may be collected from the solution by filtration. Once collected, the metal sulfide may be washed, dried, heated, crystalized, or a combination thereof.

Filtering the mixture at steps 230, 250, 245, or 265 may be accomplished using any filtration apparatus known in the art. Alternatively, the filtration step may be accomplished via decanting, centrifugation, gravity settling, or other methods known in the art or any combination thereof.

Drying may be performed by spray drying, rotary drying, tray drying, fluidized bed drying, vacuum drying, or a combination thereof. The drying may take place for 1 minute to about 24 hours at a temperature ranging from about 60° C. to about 160° C. The temperature may be about 60° C., about 61° C., about 62° C., about 63° C., about 64° C., about 65° C., about 66° C., about 67° C., about 68° C., about 69° C., about 70° C., about 71° C., about 72° C., about 73° C., about 74° C., about 75° C., about 76° C., about 77° C., about 78° C., about 79° C., about 80° C., about 81° C., about 82° C., about 83° C., about 84° C., about 85° C., about 86° C., about 87° C., about 88° C., about 89° C., about 90° C., about 91° C., about 92° C., about 93° C., about 94° C., about 95° C., about 96° C., about 97° C., about 98° C., about 99° C., about 100° C., about 101° C., about 102° C., about 103° C., about 104° C., about 105° C., about 106° C., about 107° C., about 108° C., about 109° C., about 110° C., about 110° C., about 111° C., about 112° C., about 113° C., about 114° C., about 115° C., about 116° C., about 117° C., about 118° C., about 119° C., about 120° C., about 121° C., about 122° C., about 123° C., about 124° C., about 125° C., about 126° C., about 127° C., about 128° C., about 129° C., about 130° C., about 131° C., about 132° C., about 133° C., about 134° C., about 135° C., about 136° C., about 137° C., about 138° C., about 139° C., or about 140° C.

Further processing such as crystallization may be performed. To accomplish this crystallization, the material may be heated to a temperature of about 300° C., about 400° C., about 500° C., about 600° C., or about 700° C.

In an embodiment, the method may take place as shown in the following general reaction:
1. Combine sodium sulfide and lithium chloride salt in a solvent to form a first mixture that includes lithium sulfide and sodium chloride

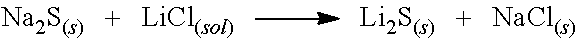

2. Add a composite containing silicon sulfide and silicon oxide to the first mixture

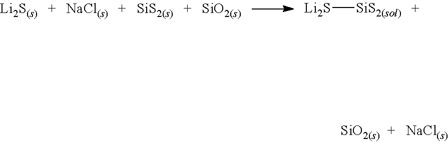

3. Filter to remove undissolved materials

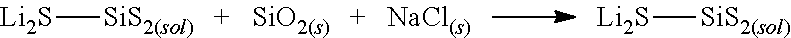

4. Add secondary sulfide to precipitate metal sulfide

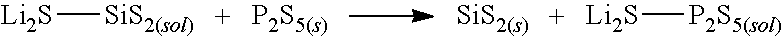

5. Filter to recover metal sulfide

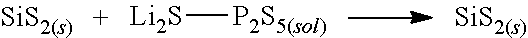

6. (Optionally) drying and heating

In another embodiment, the method may take place as shown in the following general reaction:
1. Combine sodium sulfide and lithium chloride salt in a solvent to form a first mixture that includes lithium sulfide and sodium chloride

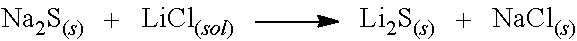

2. Add a composite containing tin sulfide and tin oxide to the first mixture

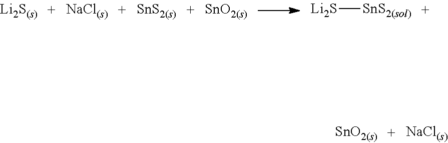

3. Filter to remove undissolved materials

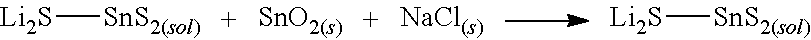

4. Add secondary sulfide to precipitate metal sulfide

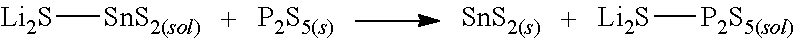

5. Filter to recover metal sulfide

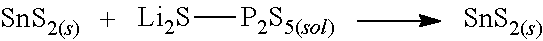

6. (Optionally) drying and heating

In another embodiment, the method may take place as shown in the following general reaction:
1. Combine sodium sulfide and lithium chloride salt in a solvent to form a first mixture that includes lithium sulfide and sodium chloride

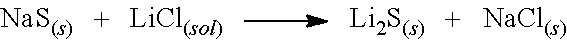

2. Add a composite containing zirconium sulfide and tin oxide to the first mixture

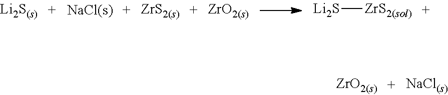

3. Filter to remove undissolved materials

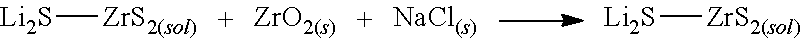

4. Add secondary sulfide to precipitate metal sulfide

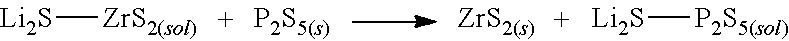

5. Filter to recover metal sulfide

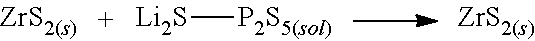

6. (Optionally) drying and heating

In another embodiment, the method may take place as shown in the following general reaction:
1. Combine sodium sulfide and lithium chloride salt in a solvent to form a first mixture that includes lithium sulfide and sodium chloride

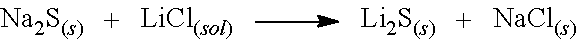

2. Add a composite containing boron sulfide and boron to the first mixture

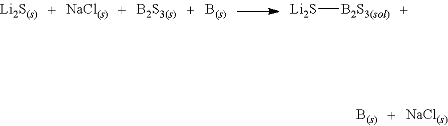

3. Filter to remove undissolved materials

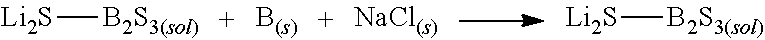

4. Add secondary sulfide to precipitate metal sulfide

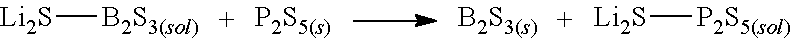

5. Filter to recover metal sulfide

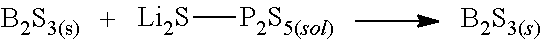

6. (Optionally) drying and heating

Unless defined otherwise, all technical and scientific terms used herein have the same meaning as commonly understood by those of ordinary skill in the art to which the disclosure belongs. Although any methods and materials similar or equivalent to those described herein can be used in the practice or testing of the subject matter of the present disclosure, preferred methods and materials are described. For the purposes of the present disclosure, the following terms are defined below.

### Exemplary Embodiments

Embodiment 1: A method for purifying a metal sulfide comprising:
combining an alkali metal sulfide, a composite comprising the metal sulfide, and an aprotic solvent to produce a mixture of undissolved materials and a solution comprising the metal sulfide and the alkali metal sulfide, wherein the metal sulfide and the alkali metal sulfide are dissolved in the solution;
removing the undissolved materials;
adding a secondary sulfide to the solution comprising the metal sulfide and the alkali metal sulfide, thereby precipitating the metal sulfide; and
collecting the metal sulfide.

Embodiment 2: The method of embodiment 1, wherein the molar ratio of the metal sulfide to the alkali metal sulfide is from 1:10 to 1:1.

Embodiment 3: The method of embodiment 1 or 2, wherein the alkali metal sulfide comprises Li₂S, LiNaS, or LiKS.

Embodiment 4: The method of any one of embodiments 1-3, wherein the metal sulfide comprises boron, silicon, germanium, antimony, or tellurium.

Embodiment 5: The method of any one of embodiments 1-3, wherein the metal sulfide comprises titanium, tungsten, silver, molybdenum, zirconium, hafnium, scandium, vanadium, chromium, manganese, iron, cobalt, nickel, copper, zinc, yttrium, niobium, technetium, ruthenium, rhodium, palladium, cadmium, tantalum, rhenium, osmium, iridium, platinum, gold, mercury, aluminum, gallium, indium, thallium, tin, lead, silicon, boron, germanium, or bismuth.

Embodiment 6: The method of any one of embodiments 1-5, wherein the solvent comprises an ether, ester, nitrile, or imine.

Embodiment 7: The method of any one of embodiments 1-6, wherein the secondary sulfide comprises P₄S₃, P₄S₄, P₄S₅, P₄S₆, P₄S₇, P₄S₈, P₄S₉ or P₄S₁₀ (P₂S₅), P₄Sₓ where 10<x<50, or any combination thereof.

Embodiment 8: The method of any one of embodiments 1-7, wherein the composite further comprises a metal oxide, metal carbide, or carbon.

Embodiment 9: A method for purifying a metal sulfide comprising:
combining a first alkali metal sulfide, a first alkali metal salt, and a solvent forming a mixture of a second alkali metal salt and a second alkali metal sulfide;
adding a composite comprising a metal sulfide to produce a mixture of undissolved materials and a solution comprising a metal sulfide and a second alkali metal sulfide;
removing the undissolved materials;
adding a secondary sulfide to the solution, thereby precipitating the metal sulfide; and
collecting the metal sulfide.

Embodiment 10: The method of embodiment 9, wherein the first alkali metal sulfide comprises Na₂S, LiNaS, LiKS, or K₂S.

Embodiment 11: The method of embodiment 9 or 10, wherein the first alkali metal salt comprises LiF, LiCl, LiBr, LiI, lithium carbonate, lithium sulfate, lithium hydroxide, or lithium phosphate.

Embodiment 12: The method of any one of embodiments 9-11, wherein the combining step further comprises an alkali earth metal selected from the group consisting of magnesium or calcium.

Embodiment 13: The method of any one of embodiments 9-12, wherein the aprotic solvent comprises an ether, ester, nitrile, or imine.

Embodiment 14: The method of any one of embodiments 9-13, wherein the second alkali metal sulfide comprises Li₂S, LiNaS, or LiKS.

Embodiment 15: The method of any one of embodiments 9, 10, and 12-14, wherein the first alkali metal salt comprises NaF, NaCl, NaBr, Nal, sodium carbonate, sodium sulfate, sodium hydroxide, sodium phosphate, KF, KCl KBr, Kl, potassium carbonate, potassium sulfate, potassium hydroxide, or potassium phosphate.

Embodiment 16: The method of any one of embodiments 9-15, wherein the metal sulfide comprises titanium, tungsten, silver, molybdenum, zirconium, hafnium, scandium, vanadium, chromium, manganese, iron, cobalt, nickel, copper, zinc, yttrium, niobium, technetium, ruthenium, rhodium, palladium, cadmium, tantalum, rhenium, osmium, iridium, platinum, gold, mercury, aluminum, gallium, indium, thallium, tin, lead, silicon, boron, germanium, or bismuth.

Embodiment 17: A method for purifying a metal sulfide comprising:
combining Na₂S, LiCl, and a nitrile solvent to form a mixture of NaCl and a second alkali metal sulfide;
adding a composite comprising a metal sulfide to produce a mixture of undissolved materials and a solution comprising the metal sulfide and the second alkali metal sulfide;
removing the undissolved materials;
adding P₂S₅ to the solution, thereby precipitating the metal sulfide; and
collecting the metal sulfide.

Embodiment 18: The method of embodiment 17, wherein the second alkali metal sulfide comprises Li₂S or LiNaS.

Embodiment 19: The method of embodiment 17 or 18, wherein the nitrile solvent comprises acetonitrile, propionitrile, butyronitrile, isobutyronitrile, benzonitrile, decanonitrile, pivalonitrile, or valeronitrile.

Embodiment 20: The method of any one of embodiments 17-19, wherein the metal sulfide comprises titanium, tungsten, silver, molybdenum, zirconium, hafnium, scandium, vanadium, chromium, manganese, iron, cobalt, nickel, copper, zinc, yttrium, niobium, technetium, ruthenium, rhodium, palladium, cadmium, tantalum, rhenium, osmium, iridium, platinum, gold, mercury, aluminum, gallium, indium, thallium, tin, lead, silicon, boron, germanium, or bismuth.

### EXAMPLES

### Example 1: (LiCl+Na₂S)+SiS₂+P₂S₅

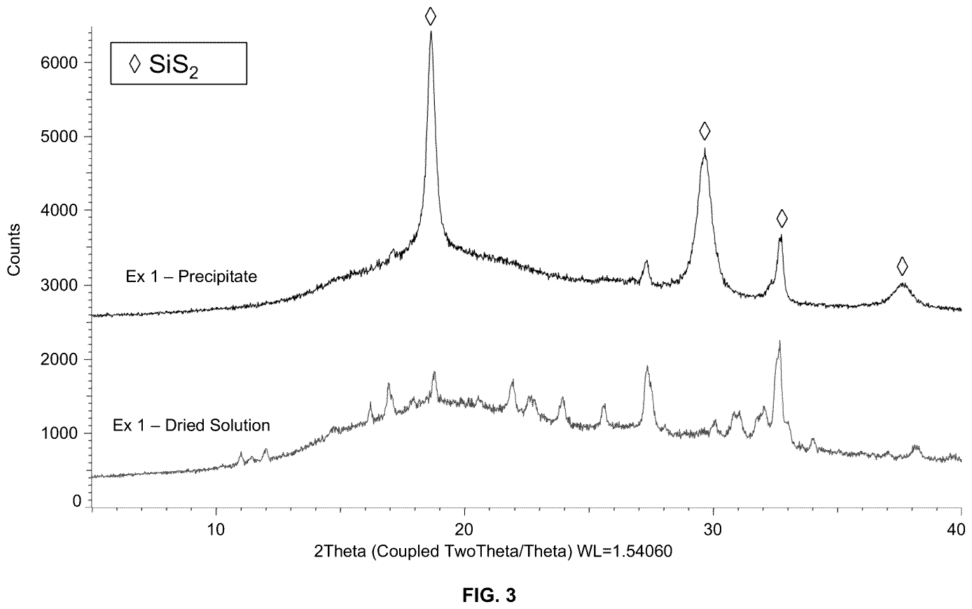

Na₂S and LiCl were added to a glass vial containing 10 mL of acetonitrile where the molar ratio between the Na₂S and the LiCl was 1:2. This mixture was stirred for 12 hours at room temperature, after which, a NaCl-containing precipitate had formed on the bottom of the vial. Pure SiS₂ is used as a SiS₂ containing composite. Without removing this NaCl-containing precipitate, SiS₂ was added to the vial where the molar ratio between the originally added Na₂S and the SiS₂ was 1:1. This mixture was stirred for 2 hours at a temperature of 65° C., after which the SiS₂ was fully solubilized leaving only the NaCl-containing precipitate in solid form. The NaCl-containing precipitate was removed from the mixture by filtration forming a clear solution. To this clear solution, P₂S₅ was added such that the molar ratio of P₂S₅ to Li₂S was 1:1. This mixture was then stirred for stirred for 2 hours at a temperature of 65° C. After the two hours, the P₂S₅ has fully solubilized and a white precipitate had formed on the bottom of the vial. The white precipitate was collected by filtration. The white precipitate was then heated to a temperature of 450° C. for 1 hour. The precipitate was then scanned using an X-ray diffractometer (XRD) and was identified to SiS₂ as shown by red scan in FIG. 3. The filtered solution was then dried by heating to a temperature of 100° C. under vacuum conditions. Once the solvent was removed, a dried composite was formed. This dried composite was then heated to a temperature of 300° C. for 1 hour. The heated composite was then scanned using an X-ray diffractometer (XRD) and shown as the blue scan in FIG. 3. This blue scan does not show any trace of SiS₂ showing that the addition of P₂S₅ forced all of the SiS₂ to precipitate out of solution.

What is claimed is:

1. A method for purifying a metal sulfide comprising:
combining an alkali metal sulfide, a composite comprising the metal sulfide, and an aprotic solvent to produce a mixture of undissolved materials and a solution comprising the metal sulfide and the alkali metal sulfide, wherein the metal sulfide and the alkali metal sulfide are dissolved in the solution;
removing the undissolved materials;
adding a secondary sulfide to the solution comprising the metal sulfide and the alkali metal sulfide, thereby precipitating the metal sulfide; and
collecting the metal sulfide.

2. The method of claim 1, wherein the molar ratio of the metal sulfide to the alkali metal sulfide is from 1:10 to 1:1.

3. The method of claim 1, wherein the alkali metal sulfide comprises Li₂S, LiNaS, or LiKS.

4. The method of claim 1, wherein the metal sulfide comprises boron, silicon, germanium, antimony, or tellurium.

5. The method of claim 1, wherein the metal sulfide comprises titanium, tungsten, silver, molybdenum, zirconium, hafnium, scandium, vanadium, chromium, manganese, iron, cobalt, nickel, copper, zinc, yttrium, niobium, technetium, ruthenium, rhodium, palladium, cadmium, tantalum, rhenium, osmium, iridium, platinum, gold, mercury, aluminum, gallium, indium, thallium, tin, lead, silicon, boron, germanium, or bismuth.

6. The method of claim 1, wherein the solvent comprises an ether, ester, nitrile, or imine.

7. The method of claim 1, wherein the secondary sulfide comprises P₄S₃, P₄S₄, P₄S₅, P₄S₆, P₄S₇, P₄S₈, P₄S₉ or P₄S₁₀ (P₂S₅), P₄Sₓ where 10<x<50, or any combination thereof.

8. The method of claim 1, wherein the composite further comprises a metal oxide, metal carbide, or carbon.

9. A method for purifying a metal sulfide comprising:
combining a first alkali metal sulfide, a first alkali metal salt, and a solvent forming a mixture of a second alkali metal salt and a second alkali metal sulfide;
adding a composite comprising a metal sulfide to produce a mixture of undissolved materials and a solution comprising a metal sulfide and a second alkali metal sulfide;
removing the undissolved materials;
adding a secondary sulfide to the solution, thereby precipitating the metal sulfide; and
collecting the metal sulfide.

10. The method of claim 9, wherein the first alkali metal sulfide comprises Na₂S, LiNaS, LiKS, or K₂S.

11. The method of claim 9, wherein the first alkali metal salt comprises LiF, LiCl, LiBr, LiI, lithium carbonate, lithium sulfate, lithium hydroxide, or lithium phosphate.

12. The method of claim 9, wherein the combining step further comprises an alkali earth metal selected from the group consisting of magnesium or calcium.

13. The method of claim 9, wherein the aprotic solvent comprises an ether, ester, nitrile, or imine.

14. The method of claim 9, wherein the second alkali metal sulfide comprises Li₂S, LiNaS, or LiKS.

15. The method of claim 9, wherein the first alkali metal salt comprises NaF, NaCl, NaBr, Nal, sodium carbonate, sodium sulfate, sodium hydroxide, sodium phosphate, KF, KCl KBr, Kl, potassium carbonate, potassium sulfate, potassium hydroxide, or potassium phosphate.

16. The method of claim 9, wherein the metal sulfide comprises titanium, tungsten, silver, molybdenum, zirconium, hafnium, scandium, vanadium, chromium, manganese, iron, cobalt, nickel, copper, zinc, yttrium, niobium, technetium, ruthenium, rhodium, palladium, cadmium, tantalum, rhenium, osmium, iridium, platinum, gold, mercury, aluminum, gallium, indium, thallium, tin, lead, silicon, boron, germanium, or bismuth.

17. A method for purifying a metal sulfide comprising:
combining Na₂S, LiCl, and a nitrile solvent to form a mixture of NaCl and a second alkali metal sulfide;
adding a composite comprising a metal sulfide to produce a mixture of undissolved materials and a solution comprising the metal sulfide and the second alkali metal sulfide;
removing the undissolved materials;
adding P₂S₅ to the solution, thereby precipitating the metal sulfide; and
collecting the metal sulfide.

18. The method of claim 17, wherein the second alkali metal sulfide comprises Li₂S or LiNaS.

19. The method of claim 17, wherein the nitrile solvent comprises acetonitrile, propionitrile, butyronitrile, isobutyronitrile, benzonitrile, decanonitrile, pivalonitrile, or valeronitrile.

20. The method of claim 17, wherein the metal sulfide comprises titanium, tungsten, silver, molybdenum, zirconium, hafnium, scandium, vanadium, chromium, manganese, iron, cobalt, nickel, copper, zinc, yttrium, niobium, technetium, ruthenium, rhodium, palladium, cadmium, tantalum, rhenium, osmium, iridium, platinum, gold, mercury, aluminum, gallium, indium, thallium, tin, lead, silicon, boron, germanium, or bismuth.
